(19) United States
(12) Patent Application Publication
(10) Pub. No.: US 2006/0210169 A1
(43) Pub. Date: Sep. 21, 2006

(54) Apparatus and method for simulated sensor imagery using fast geometric transformations

(75) Inventors: Mark Colestock, Brighton, MN (US); Yang Zhu, St. Paul, MN (US)

Correspondence Address: HOWREY LLP, C/O IP DOCKETING DEPARTMENT, 2941 FAIRVIEW PARK DR, SUITE 200, FALLS CHURCH, VA, 22042-2924, US

(73) Assignee: General Dynamics Advanced Information Systems, Inc.

(21) Appl. No.: 11/359,365

(22) Filed: Feb. 23, 2006

Related U.S. Application Data
(60) Provisional application No. 60/657,703, filed on Mar. 3, 2005.

(51) Int. Cl. G06K 9/00; G06K 9/64; G06K 9/68

(52) U.S. Cl. 382/218; 382/103; 382/104; 382/217

(57) ABSTRACT

The invention pertains generally to image processing. More specifically, the invention relates to the processing of sensor imagery using generated imagery. Embodiments of the invention include receiving sensor data, vehicle data, GPS data and accessing a database to obtain a pre-stored image of a target area. The pre-stored image of the target area may then be pre-processed by transforming the image into a warped coordinate system and adding visual effects to create projection image of the target area. The projection image may then be compared to a current image of the target area to determine a three-dimensional location of a target located in the target area. Additional embodiments of the invention include the use of a feedback loop for refinement and correction of results and/or the use of parallel processors to speed processing.

### CROSS REFERENCE TO RELATED APPLICATIONS

This application claims the benefit of U.S. provisional patent application 60/657,703, filed Mar. 03, 2005 and entitled “System and Method for Shadow Ray Projection Using Fast Geometric Transformations” and U.S. provisional patent application 60/675,476, filed Apr. 28, 2005 and entitled “System and Method for Simulated Sensor Imagery Using Fast Geometric Transformations.” The foregoing applications are hereby incorporated herein by reference in their entirety.

### FIELD OF THE INVENTION

The invention pertains generally to image processing. More specifically, the invention relates to the processing of sensor imagery using generated imagery and three-dimensional computer graphics processing techniques.

### BACKGROUND OF THE INVENTION

Image registration is the process of associating a first image with a second image. Specifically, the process may be used to determine the location of a target feature present in a received image. Generally, a stored image in which certain parameters (such as latitude, longitude or altitude) for certain features are known may be associated with an image in which these parameters are unknown. For example, this may include associating a previously stored image with an image gathered by an optical sensor, a radar sensor, an infrared (“IR”) sensor or other known devices for gathering image data.

The registration of two images is generally performed by matching or correlating the two images. This correlation may then assist a user or a processor in determining the location of specific features that may appear in a received image but not in a stored image. For example, a system may contain a database having topographic images which include the locations of geographic features (such as mountains, rivers or similar features) and man-made features (such as buildings). These images may be stored by a processor attached to a sensor. The sensor may gather image data to create a second image showing the same geographical and man-made features. However, in the second image, a feature not present on the topographical image (such as a vehicle) may be present. Upon receipt of the second image, a user may wish to determine the location of the new feature. This may be accomplished using an image registration technique.

As explained above, the topographic image and the second image may be correlated. This correlation may utilize control points, which are points or features common to both images for which their location in the topographic image is known, to “line up” the images. Based on the control points, a processor may extrapolate the location of the unknown feature in the second image based on the known location of geographical and man-made features present in both images.

Previous image registration techniques have utilized a traceback, or “ray tracing,” technique for correlating the two images. This technique involves correlating images based on the sensor and collection characteristics of each image as each image is received. The sensor and collection characteristics, such as the graze angle, the squint angle and the range, may be used to correlate multiple images by lining them up using the geometrical orientation of the sensor when the images were collected. This may entail theoretically tracing data points back to the sensor to determine a three-dimensional point for each pixel in the image.

However, these prior art techniques present many challenges in environments where image registration must be performed quickly. For example, the traceback technique is not well suited for use in avionics environments which require “on-the-fly” or “real time” processing of received images. Due to the complexity of the required calculations, the processing used in the traceback technique requires too much time to “line up” the images based on geographical orientation. Therefore, it may not be possible to provide an operator or user with the location of an object in real time, or even near real time, so that the user or operator may identify the object and react to the location of the object. Further, the prior art techniques are prone to many different errors in processing—it is difficult to correlate the images because of varying collection geometries —which may lead to skewed results.

Additionally, images created directly from image data received by a sensor may appear skewed when viewed in the “earth” coordinate system due to geometric distortions formed when the sensor collects the data. For example, radar shadow may occur behind three-dimensional features in the image at smaller off-nadir angles. Additionally, foreshortening may appear when a radar beam reaches the top of a tall feature before it reaches the base. This may cause the image of the top of the feature to appear closer to the sensor than the bottom and may cause layover effects in the image—the slope of the feature may appear skewed in the image when compared to its real-world appearance. Other distortions may also appear in an image created from image data received by a sensor. These may include, for example, distortions due to the squint angle of the sensor, the reflectivity of the terrain being imaged, the texture of the terrain being imaged and other environmental effects.

To account for these distortions, many prior art image processing techniques have generally pre-processed a received image to account for the distortions before an image is displayed to a user or compared to other images. However, in addition to the fact that pre-processing image data received by a sensor is time-consuming, data may be lost in the process.

Therefore, there is a need for an apparatus and method for quickly performing image registration of multiple images without loss of image data during pre-processing.

### SUMMARY OF THE INVENTION

The invention pertains generally to image processing. More specifically, the invention relates to the processing of sensor imagery using generated imagery and three-dimensional computer graphics processing techniques.

In one embodiment of the present invention, a target location apparatus may include a sensor for receiving real-time image data of a target area and a processor. The processor may include an effects processor configured to access a database, the database having at least one pre-stored image of the target area in a database coordinate system, wherein the effects processor is further configured to retrieve a pre-stored image of the target area from the database and to transform the pre-stored image to a warped coordinate system, a visual processor configured to receive the transformed pre-stored image and to add visual effects to the transformed pre-stored image, the visual processor creating a projection image of the target area, and an image processor configured to receive the projection image and the real-time image data, to convert the real-time image data into an image of the target area and to compare the projection image to the image of the target area. Additionally, the processor may be configured to output a location of a target in the target area based on the comparison of the projection image with the image of the target area.

An alternate embodiment of the present invention may include a method of processing sensor data, the method comprising the steps of receiving real-time image data of a target area from a sensor, converting the real-time image data of the target area into an image of the target area, receiving a pre-stored image of the target area in a database coordinate system, transforming the pre-stored image of the target area into an image of the target area in a warped coordinate system and transforming the image of the target area in a warped coordinate system to create a projection image of the target area. The method may also include the steps of comparing the projection image to the image of the target area and determining the location of a target in the target area based on the comparison of the projection image and the image of the target area.

These and other objects and advantages of the invention will be apparent from the following description, the accompanying drawings and the appended claims.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 illustrates an exemplary system for using the present invention.

FIG. 2 illustrates a sensor system incorporating one embodiment of the present invention.

FIGS. 3A, 3B and 3C illustrate alternate embodiments of the present invention.

FIG. 4 shows a flowchart of the processing steps taken by alternate embodiments of the present invention.

### DETAILED DESCRIPTION OF THE INVENTION

The present disclosure will now be described more fully with reference to the figures in which various embodiments of the present invention are shown. The subject matter of this disclosure may, however, be embodied in many different forms and should not be construed as being limited to the embodiments set forth herein.

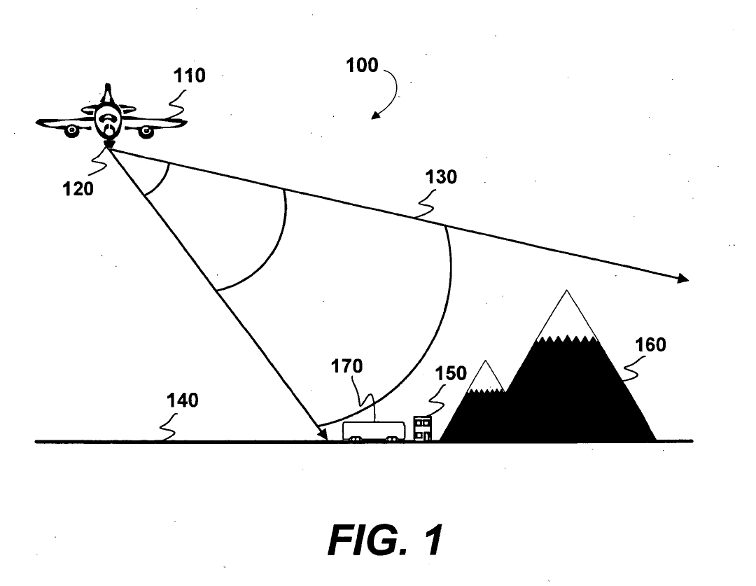

FIG. 1 illustrates an exemplary system for using the present invention. The system 100 may include an aircraft 110 equipped with a radar sensor 120. The radar sensor 120 may be configured to collect image data related to geographic and man-made features and objects located in the target area 130 (the radar sensor's field of view). In the embodiment illustrated in FIG. 1, features and objects present in the target area 130 of the radar sensor 120 include the ground 140, a building 150, a vehicle 170 and a mountain 160. Of course, depending on the type of sensor used, any geographic or man-made feature or object may be detected by the sensor 120. These features and objects may include, for example, bodies of water, valleys, roadways, cities, vehicles and even human beings.

While FIG. 1 illustrates a system having a radar sensor 120, it is contemplated that the present invention may be used in a system having any type of sensor for receiving image data as would be known to one of skill in the art. These different sensors include, but are not limited to, a Doppler radar sensor, a SAR radar sensor, an IR sensor, a photographic camera or an electro-optical sensor such as a light detection and ranging (“LIDAR”) sensor. Further, while FIG. 1 illustrates a system having a sensor 120 attached to an aircraft 110, it is also contemplated that the sensor may be attached to any type of vehicle including spacecraft, land vehicles and boats. Further, the sensor may be attached to a stationary sensor mount or may be carried by a human being.

In the embodiment illustrated in FIG. 1, the aircraft 110 may pass by features 140-160, imaging the features as they appear in the target area 130. The collection of the image data may occur, depending on the sensor, at any range or angle with respect to the features 140-160. In alternative embodiments, the sensor 120 may be located on the ground 140 or on a vehicle placed on the ground 140. In these alternative embodiments, the sensor may collect image data related to any or all features capable of being imaged by the sensor 120.

As discussed above, the sensor 120 may collect current image data pertaining to a feature that has not always been present in the target area 130 (such as the vehicle 170 illustrated in FIG. 1). The three-dimensional location of this feature may not be known as it may not appear on any pre-stored maps or previously received images of the target area 130. As such, the present invention may permit a user to quickly and accurately determine the three-dimensional location of the feature as it currently appears in the target area 130 without loss of current image data.

The present invention may be utilized in any environment or for any purpose in which it may be desirable to calculate the three-dimensional location of a feature located in the target area of a sensor. For example, this may include avionics environments where the location of the feature may be desirable for navigation purposes. Further, the invention may be used in military environments to calculate the location of, or changes in, the location of an enemy installation for bombing or surveillance purposes. Additionally, the invention may be used whenever it is desirable to overlay two images to perform a comparison of the two images.

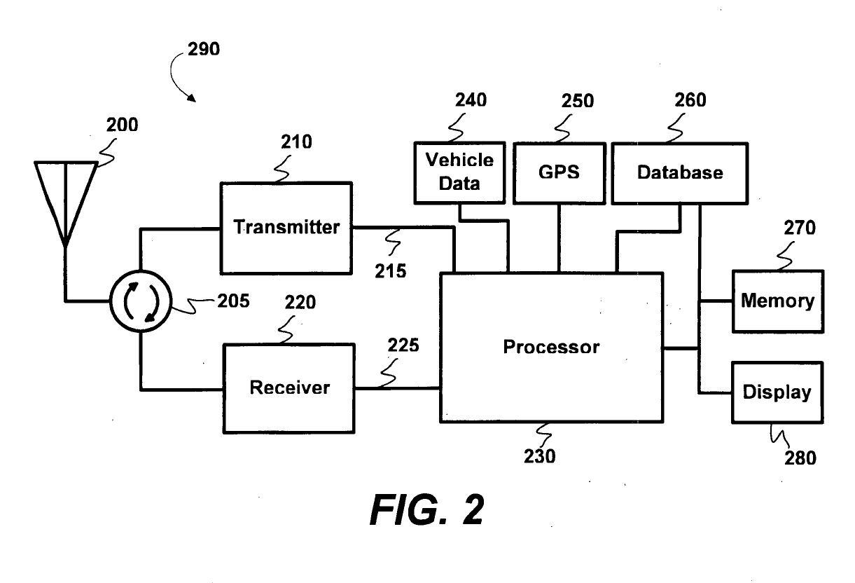

FIG. 2 illustrates a sensor system incorporating one embodiment of the present invention. In the embodiment illustrated in FIG. 2, a sensor system 290 includes an antenna 200 connected to a circulator 205. The circulator, in turn, is connected to both a transmitter 210 and a receiver 220. As discussed above, the sensor system 290 may incorporate any type of imaging sensor, such as a radar sensor, a SAR radar sensor, an IR sensor, a photographic camera or an electo-optical sensor such as a light detection and ranging (“LIDAR”) sensor. Thus, the antenna 200, circulator 205, transmitter 210 and receiver 220 may be configured to transmit and receive any type of electromagnetic signals used for imaging. Further, while FIG. 2 illustrates the use of a transmitter 210 and circulator 205, it is contemplated that the system may include a passive receiver and no transmitter. In this embodiment, the receiver 220 may be directly connected to the antenna 200 and the transmitter 210 and circulator 205 may be eliminated.

In the embodiment illustrated in FIG. 2, a processor 230 incorporating the present invention may be configured to receive sensor data 215 from a transmitter 210, current image data 225 from a receiver 220, vehicle data 240 and Global Positioning System (“GPS”) data 250. Further, the processor may be configured to receive data from or access a database 260. While hard-line attachments are shown among the various elements of the sensor system 290 illustrated in FIG. 2, it is contemplated that a wireless connection or any other type of data transference connection known to one of skill in the art may be utilized for connecting the various elements of the sensor system 290.

The processor 230 may be configured to receive sensor data 215 related to the sensor system 290 from the transmitter 210. This sensor data 215 may include, for example, the graze angle and the squint angle of the antenna 200 and the overall orientation of the sensor system 290 with respect to the ground while it is being used for collecting current image data. The processor 230 may also be configured to receive current image data 225 collected by the receiver 220. Where a passive receiver 220 is used, the sensor data 215 may be transmitted to the processor 230 by the receiver 220.

The processor 230 may receive vehicle data 240 regarding the vehicle upon which the sensor system 290 is mounted as well as GPS data 250 regarding the location of the vehicle upon which the sensor system 290 is mounted. As discussed above with respect to FIG. 1, the sensor system 290 may be mounted on any type of vehicle including aircraft, spacecraft, land vehicles and boats. The sensor system 290 may also be attached to a stationary sensor or may be carried by a human being. When the sensor system 290 is mounted on a vehicle, the vehicle data 240 received by the processor 230 may include information regarding the direction of movement of the vehicle, the velocity of the vehicle, the acceleration of the vehicle, the altitude of the vehicle, the orientation of the vehicle with respect to the ground or any other type of information regarding the movement of the vehicle. When the sensor system 290 is mounted on an aircraft, the vehicle data 240 may also include information from an inertial navigation system. Additionally, the time at which imaging takes place may be recorded. In one embodiment, current weather conditions may be recorded from a weather report or other source of weather information.

Further, while the entire sensor system 290 is illustrated in FIGS. 1 and 2 as being attached and mounted on a vehicle, it is contemplated that the antenna 200 and its relevant components may be mounted separately from the processing components. For example, the antenna 200, transmitter 210 and receiver 220 may be mounted on a human being while the processor 230 may be located at a stationary base. The processor 230 may receive one or more wireless transmissions with sensor data 215, image data 225, vehicle data 240 and GPS data 250 from the antenna 200, transmitter 210 and receiver 220. Using this data, the processor may then perform calculations and output the results at the stationary base or may even wirelessly transmit the results to other users.

Additionally, the processor 230 may access and receive information from a database 260. As discussed in greater detail below, this database 260 may include pre-stored topographic maps. The database may also contain digital elevation models, digital point precision databases, digital terrain elevation data or any other type of information regarding the three-dimensional location of terrestrial geographic or man-made features.

The processor 230 may be configured to provide an output which may be stored in memory 270, displayed to a user via a display 280 and/or added to the database 260 for later processing or use. Memory 270 may include, for example, in internal computer memory such as random access memory (RAM) or an external drive such as a floppy disk or a CD-ROM. Further, the output may be stored on a computer network or any similar structure known to one of skill in the art. The display 280 may include, for example, a standard computer monitor, a touch-screen monitor, a wireless hand-held device or any other means for display known to one of skill in the art.

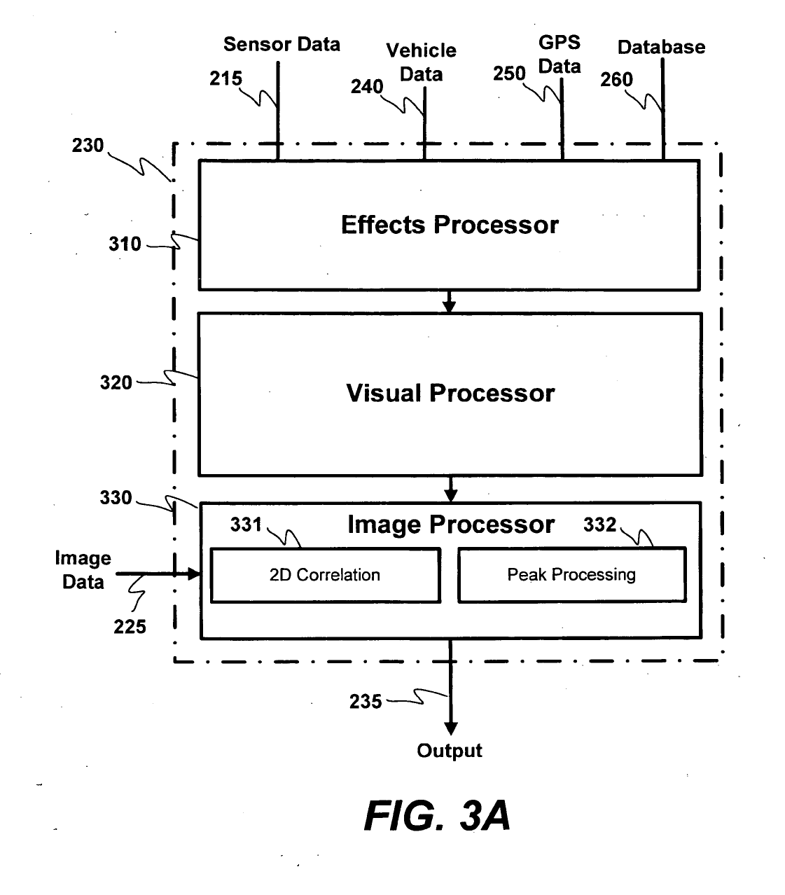

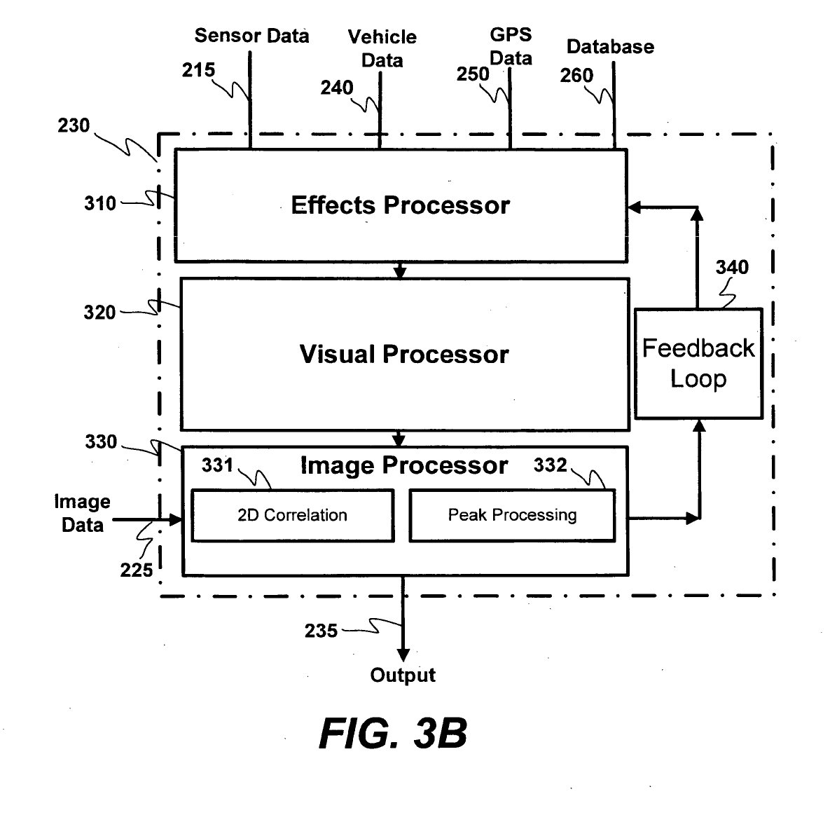

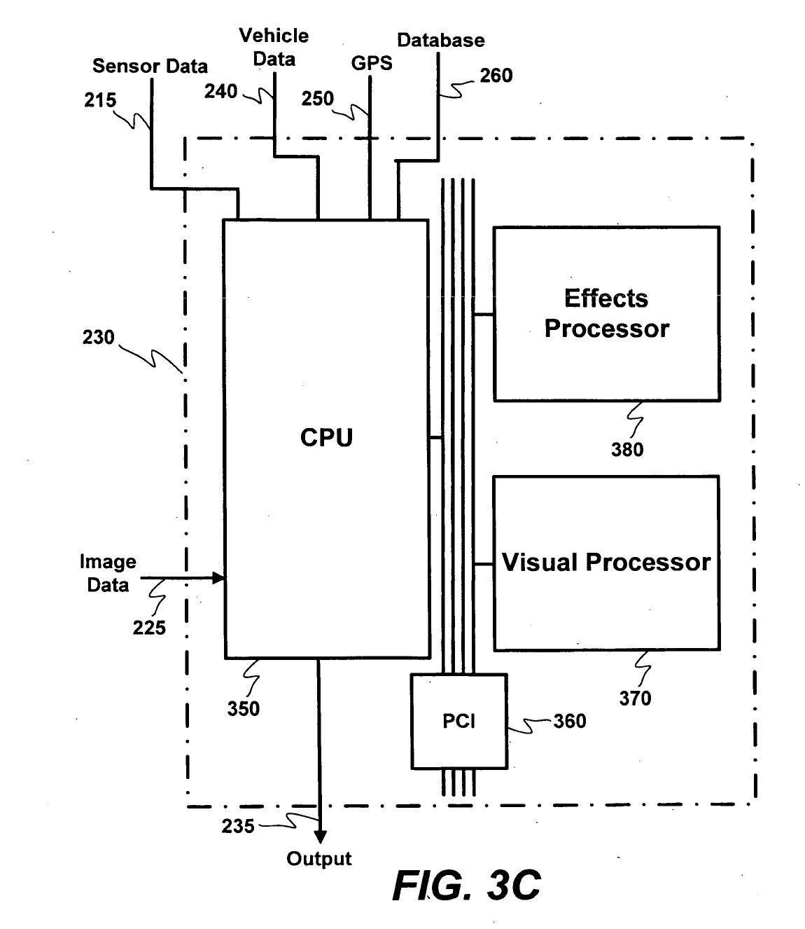

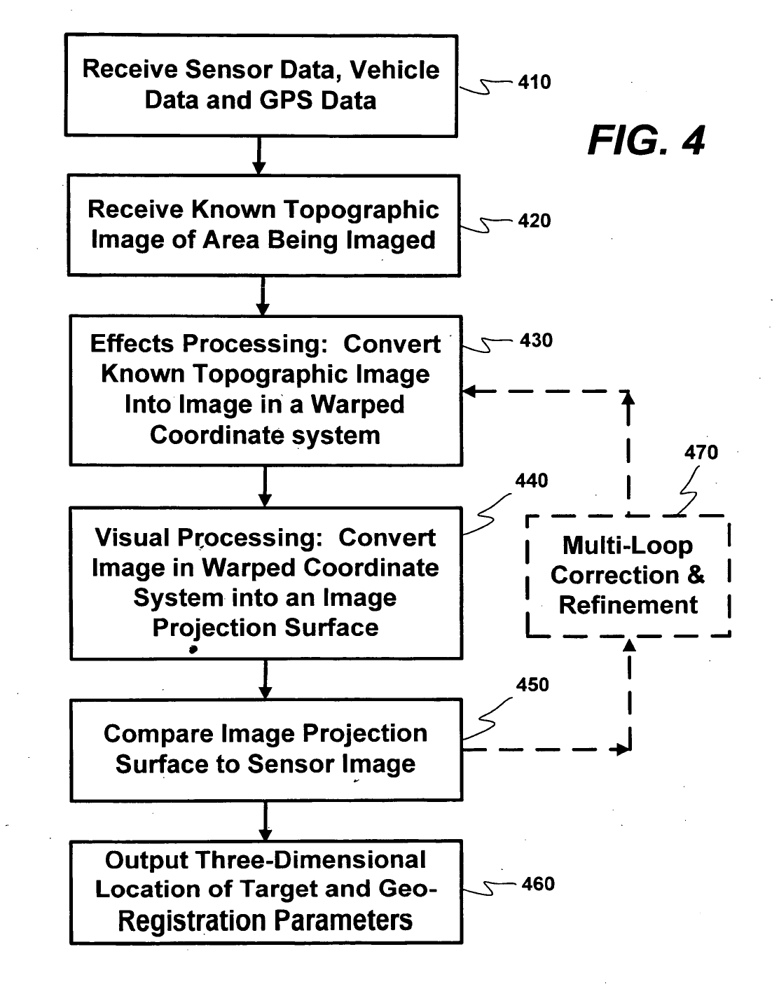

FIGS. 3A, 3B and 3C illustrate alternate embodiments of the present invention. Further, FIG. 4 shows a flowchart of processing steps taken by alternate embodiments of the present invention. While these embodiments are illustrated using multiple hardware processing components, it is contemplated that certain embodiments of the present invention may be realized as software incorporated with hardware. The software may exist in a variety of forms, both active and inactive. For example, the software may exist as a computer software program (or multiple programs) comprised of program instructions in source code, object code, or executable code, firmware program(s) or hardware description language (HDL) files. Any of the above may be embodied on a computer readable medium which may include storage devices and signals, in compressed or uncompressed form. Exemplary computer readable storage devices may include conventional system RAM, read-only memory (ROM), erasable programmable ROM (EPROM), electrically erasable programmable ROM (EEPROM) and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same may be true of computer networks in general.

Further, each illustrated embodiment of the present invention utilizes multiple processors arranged in various configurations. It is contemplated that each of the processors may be any type of processor known to one of skill in the art. For example, each of the processors may be any type of digital signal processor (“DSP”) including a Peripheral Component Interconnect (“PCI”) Mezzanine Card (“PMC”) graphics processor or a Field Programmable Gate Array (“FPGA”) processor. While any conventional processor may be utilized by the present invention, it should be noted that graphics processors are ideally suited for the fast transformations and calculations of imagery performed by the present invention.

In the embodiment illustrated in FIG. 3A, the processor 230 may include an effects processor 310, a visual processor 320 and an image processor 330. As illustrated by step 410 (FIG. 4), while current image data regarding a target area 130 is collected by the sensor system 290, the effects processor 310 may receive current real-time sensor data 215, current real-time vehicle data 240 and current real-time GPS data 250. Upon receipt of the data 215, 240 and 250, the effects processor 310 may calculate the location of the target area 130 currently being imaged by the sensor system 290. This calculation may utilize any or all of the sensor data 215, vehicle data 240 or GPS data 250 (which may include time data) to aid the processor in determining the location of the target area 130.

As illustrated by step 420 (FIG. 4), once the location of the target area 130 has been determined, the effects processor 310 may access the database 260 to retrieve a pre-stored image which may include an image of the target area 130. The pre-stored image, as discussed above, may be a topographical map, a digital elevation model, a digital point precision database, digital terrain elevation data or any other type of image or information capable of providing the three-dimensional location of terrestrial geographic or man-made features present in the target area 130 currently being imaged.

As discussed above, many prior art image registration techniques have pre-processed current image data prior to comparing the image data to a pre-stored image. In addition to the fact that this technique is time-consuming, data may be lost in the process. As such, the present invention may process the pre-stored images as opposed to the current image data, thereby reducing processing time once image data 225 related to the target area 130 is received. This may allow for a user to obtain a fast and accurate three-dimensional location of a target located in the target area 130 without loss of image data.

Once the effects processor 310 retrieves the pre-stored image from the database 260, the pre-stored image may be transformed so that a direct comparison between an image created from the current image data 225 and the pre-stored image may be performed. As illustrated by step 430 (FIG. 4), the effects processor 310 may perform an initial calculation to transform the pre-stored image into an image in a warped coordinate system. This transformation may include reducing the size of and removing a portion of the pre-stored image so that only the area corresponding to the area currently being viewed by the sensor (the target area 130) and the immediate surrounding area appears in the pre-stored image. Further, the pre-stored image may be transformed from the “world” coordinate system into a wedged coordinate system which may be substantially identical to the coordinate system of images created directly from the image data 225.

The transformation of the pre-stored image into the wedged coordinate system may be accomplished by applying various combinations of matrices to the pre-stored image. These matrices may translate, rotate, scale and stretch the pre-stored image. The matrices may be any type of translation, rotation, scaling and perspective viewing matrices known in the art. In an exemplary embodiment, the matrices may be similar to those used in the graphics processing arts (for example, 3D computer graphics processing) for moving a set of pixels within an image.

When the present invention is incorporated with a passive sensor system in which the source of electromagnetic energy is not co-located with the receiver, a simulated source matrix may also need to be applied to the pre-stored image to align the pre-stored image with a current image of the target area 130. This may involve calculating and applying the geometrical and physical parameters of the current source of electromagnetic energy being utilized by the sensor system 290 to the pre-stored image so that the pre-stored image appears to be imaged using the same source of electromagnetic energy. Thus, the source used for the pre-stored image should appear to be located at the same angular position in which the source of electromagnetic energy currently being utilized by the sensor system 290 is located. To determine the location of the source, the effects processor may take into account any or all of the sensor data 215, vehicle data 240, GPS data 250, time data or any other data which may aid the processor in determining the present location of the source. In one embodiment of the present invention, the shadows casted by the source of electromagnetic energy may be used as a reference for aligning the images.

For example, in embodiments where the present invention is incorporated with a passive receiver which receives reflections of light (from sources such as, for example, sunlight, moonlight or flood lights), the shadows casted by a feature may appear closer to the sensor in the current image. However, the pre-stored image may illustrate the same shadows in a different orientation. Therefore, the pre-stored image may be transformed into a wedged coordinate system as discussed above but may also be transformed so that the pre-stored image appears to be taken with a source located at the same location as the source being used to image the current scene. This may be accomplished by applying the physical and geometric properties of the light source(s) so that the shadows are oriented in the pre-stored image as they will be oriented in the current image due to the location of the source(s).

Upon completion of the transformation of the pre-stored image into a warped coordinate system, the pre-stored image in a warped coordinate system may next be transmitted to or accessed by the visual processor 320. As illustrated by step 440 (FIG. 4), the visual processor 320 may perform additional processing to create a projection image. This additional processing may include adding visual effects overlays to the pre-stored image in a warped coordinate system. These visual effects may serve to simulate current conditions seen by the sensor system 290 or distortions that may be present in current image data of the target area 130, as discussed above. The effects may include, for example, simulations of distortion due to radar squint, radar shadow, layover, reflectivity or environment. Further, the effects may include a simulation of expected returns due to different surface textures such as snow, sand, ice, water or any other geographical or man-made surface texture.

These effects overlays may serve to produce an image more closely matched to a current image of the target area 130 received by the sensor system 290. Taking into account any or all of the sensor data 215, vehicle data 240, GPS data 250 and other data such as weather conditions and environmental factors, the visual effects may be added using a combination of effect functions which may serve to transform the pre-stored image in a warped coordinate system. These effect functions may include mathematical functions known in the computer graphics processing arts which may serve to simulate, for example, reflection and brightness of target features or squint effects due to sensor geometry.

As discussed above, the effect functions may serve to transform the pre-stored image so that it appears to be taken under conditions identical to the conditions currently seen by the sensor system 290. Additionally, adding visual effects to the image in this manner results in far less computing operations than used in prior art image registration techniques. For example, radar shadow effects may be added to the image by performing a visibility test on the transformed image from the energy-casting source. However, due to the prior transformation of the pre-stored image into a warped coordinate system, the visibility test used by the present invention requires only a 2D sorting process rather than the traditional 3D intersection processing technique used by prior art image registration techniques.

Upon completion of step 440, the pre-stored image received from the database 260 has now been projected into a projection image in a coordinate system that will closely match the coordinate system of current image data 225 collected by the sensor 290. This projection image may also include any distortions or effects that may be present in the current image data 225. Because the projection image and a current image of the target area 130 will so closely match, a direct comparison between a current image and the projection image may be performed once current image data 225 is received.

The projection image may next be transmitted to or accessed by the image processor 330. The image processor 330 may include a two-dimensional (“2D”) correlation processor 331 and a peak processor 332. In addition to receiving or accessing the projection image, the image processor 330 may also be configured to receive or access current image data 225 of the target area 130 received by the receiver 220 of the sensor system 290. The image processor 330 may convert the image data 225 into a real-time image of the target area 130 currently being imaged. Alternatively, a separate processor (not shown) may perform the conversion of the image data 225 into a real-time image of the target area 130 currently being imaged and pass the real-time image along to the image processor 330.

As discussed above, the real-time image of the target area 130 currently being imaged may include a target feature (such as the movable vehicle 170 illustrated in FIG. 1 or a feature newly appearing in the target area) that does not appear in any pre-stored images of the target area. Thus, the location of the target feature may be unknown. As such, a user may wish to determine the three-dimensional location of this target feature. As illustrated by step 450 (FIG. 4), this may be accomplished by performing a comparison of a current image of the target area 130, including the target feature, with a projection image created from a pre-stored image of the target area 130. As discussed above, the pre-stored image used for creation of the projection image may include features present in the current image whose three-dimensional locations are known.

The 2D correlation processor 331 may receive or access both the projection image from the visual processor 320 and a current image of the target area 130. The 2D correlation processor 331 may then correlate the projection image and the current image so that the two images overlap, or correlate. This correlation may be accomplished by “lining up” corresponding features present in both images (such as a mountain, a building or a similar feature). Any known correlation techniques may be utilized for this correlation. However, in an exemplary embodiment, two-dimensional fast fourier transforms (“FFT”) and inverse FFTs may be utilized to align the images in a frequency domain. Further, filtering and amplification of one or both of the images may be required to remove any distortion due to weak signals.

Additionally, the 2D correlation processor 331 may determine georegistration parameters which may be used for determining the location of target features present in the target area 130. The parameters may also be stored for use at a later time for quickly overlaying the current image with a previous image that has been georegistered. This may permit an operator to compare the two images and make determinations of the location of target features in either of the images. Further, it may permit an operator to correlate the current image of the target area 130 with an image of the target area 130 (such as a photograph or a topographic map) in the future.

Once the correlation has been performed, the peak processor 332 may process the two images to quickly determine the three-dimensional location of the target feature present in the target area 130. This determination may be performed using any known interpolation technique. For example, the interpolation may be performed using any technique known by those of skill in the art (such as, for example, the spatial interpolation techniques used in 3D polygon shading processing).

The interpolation may be accomplished by first mapping the target image into the coordinate system of the pre-stored image using the georegistration parameters. Next, a known interpolation technique may be used to interpolate the location of the target using the known three-dimensional location of features present in the pre-stored image which was used to create the projection image. Additionally, the georegistration parameters calculated by the 2D correlation processor 331 may be used in the interpolation calculation. These interpolation technique(s) used by the present invention may include, but are not limited to, bilinear or bicubic techniques as will be known to those of skill in the art. This interpolation may permit an operator to select any target feature located in current image, and the image processor 330 may output the three-dimensional location of that target feature.

It should be noted that the pre-processing steps (i.e. the creation of a projection image) discussed above with regard to the effects processor 310 and the visual processor 320 may be performed at any time prior to, during or after the receipt of current image data 225 from the receiver 220. If the projection image is created prior to or during the receipt of current image data 225, a comparison of the projection image with a current image may be performed in real-time or near real-time as the image data 225 is received. This may allow a user to quickly and accurately determine the location of a target feature present in the target area 130.

For example, a pilot may be given a flight plan prior to take-off which lays out the path of flight and the target areas which are to be imaged using a radar sensor. A projection image for each of the target areas, based on the flight plan, may then be created prior to take-off and stored on-board the aircraft for later processing by the image processor 330. Alternatively, a projection image may be created as the pilot is flying, utilizing real-time data regarding the sensor, the aircraft and the location of the sensor with respect to the target area. Thus, during flight, the real-time or near real-time location of features of interest (such as movable vehicles) in the target area which are not located on a pre-stored image of the target area may be calculated using the previously calculated and stored projection image. The location of these features may then be reported in real-time, or near real-time, to the pilot, an air-traffic controller, a mission control center or any other person or entity which may be able to utilize the location information. Further, the location of these features may be stored for later use.

As illustrated by step 460, the image processor 330 may be configured to output the georegistration parameters which may be used for later correlations of the real-time image of the target area with a pre-stored image of the target area as well as three-dimensional location of a target feature in the target area 130. The parameters and locations may then be displayed to an operator or stored for later processing or use. Alternatively, as illustrated in FIG. 3B and by step 470 (FIG. 4), the image processor 330 may output the results to a feedback loop 340 for further processing prior to outputting the final results.

During the initial processing (discussed above with reference to FIG. 3A) to create a projection image, the processor 230 may be required to make some approximations and estimates such as, for example, the range and width of the current target area (used in the transformation to the warped coordinate system) and the types and amount of visual effects required to match the projection image to the real-time image of the target area 130. As a result, the initial calculation of the georegistration parameters and target feature locations may not be as accurate and refined as desired. Accordingly the output of the image processor 320 may be fed through the feedback loop 340 and back to the effects processor 310 for further correction and refinement of the georegistration parameter and location calculations.

Upon receipt of the output of the image processor 330 from the feedback loop 340, the effects processor 310 may perform a calculation to determine any differences between the projection image and the current image of the target area 130. This calculation may be performed by assessing the accuracy of the correlation of the two images. Taking into account any differences between the two images, the effects processor 310 may then make necessary adjustments to the matrices used for the transformation of the pre-stored image into a warped coordinate system. Further, the visual processor 320 may make necessary adjustments to the visual effects matrices used during the initial processing so that the projection image and the current image of the target area 130 more closely correlate with one another. This correction and refinement iteration (using the feedback loop 340) may be utilized as many times as necessary to obtain accurate and reliable results of the correlation of the projection image with the current image of the target area 130.

FIG. 3C illustrates yet another embodiment of the present invention. The embodiments discussed above with respect to FIGS. 3A and 3B are illustrated as utilizing a single channel processing system. As an alternative to the single channel embodiments, the present invention may be configured so as to utilize multiple processors arranged in a parallel configuration, as illustrated in FIG. 3C. In the embodiment shown in FIG. 3C, a computer processing unit (“CPU”) 350 may receive the sensor data 215, vehicle data 245 and GPS data 255 and may be configured to access the database 260. The CPU 350 may also receive the current image data 225.

The CPU 350 may be configured to control the receipt of data, as discussed above, and the transfer of data to and from other processors through a PCI bus 360. The effects processor 380 and the visual processor 370 may be attached to the PCI bus 360. The CPU may also perform the functions of the image processor illustrated in FIGS. 3A and 3B in addition to the feedback loop 340 illustrated in FIG. 3B. Alternatively, a separate image processor (not shown) may be connected in parallel to the PCI bus 360 in the same manner as the effects processor 380 and the visual processor 370.

The parallel processing embodiment of the present invention, illustrated in FIG. 3C, may allow for even faster creation of the projection image and faster processing of the received current image data than the single channel embodiments illustrated in FIGS. 3A and 3B. Because the effects processor 380 and the visual processor 370 may be connected in parallel, they may perform multiple computations for different images at the same time. That is, the effects processor 380 may be utilized to transform a pre-stored image of a first target area into a warped coordinate system. while the visual processor may be simultaneously utilized to create a projection image of a second target area. Thus, data may be continuously received by the processor 230 and the three dimensional location of targets in multiple target areas may be calculated simultaneously, or near simultaneously, in real-time or near real-time.

The foregoing descriptions of specific embodiments of the present invention are presented for purposes of illustration and description. They are not intended to be exhaustive or to limit the invention to the precise forms disclosed. Obviously, many modifications and variations are possible in view of the above teachings. While the embodiments were chosen and described in order to best explain the principles of the invention and its practical applications, thereby enabling others skilled in the art to best utilize the invention, various embodiments with various modifications as are suited to the particular use are also possible. The scope of the invention is to be defined only by the claims appended hereto, and by their equivalents.

What is claimed is:

1. A target location apparatus comprising:
a sensor for receiving real-time image data of a target area; and
a processor including:
an effects processor configured to access a database, the database having at least one pre-stored image of the target area in a database coordinate system, wherein the effects processor is further configured to retrieve a pre-stored image of the target area from the database and to transform the pre-stored image to a warped coordinate system;
a visual processor configured to receive the transformed pre-stored image and to add visual effects to the transformed pre-stored image, the visual processor creating a projection image of the target area; and
an image processor configured to receive the projection image and the real-time image data, to convert the real-time image data into an image of the target area and to compare the projection image to the image of the target area;
wherein said processor outputs a location of a target in the target area based on the comparison of the projection image with the image of the target area.

2. The target location apparatus of claim 1, wherein said sensor is an electro-optical sensor.

3. The target location apparatus of claim 1, wherein said sensor is a radar sensor.

4. The target location apparatus of claim 1, wherein said sensor is a SAR radar sensor mounted on a vehicle.

5. The target location apparatus of claim 4, wherein said vehicle is an aircraft.

6. The target location apparatus of claim 4, wherein said vehicle is a spacecraft.

7. The target location apparatus of claim 4, wherein said vehicle is a land-vehicle.

8. The target location apparatus of claim 1, wherein said sensor is mounted on a stationary sensor mount.

9. The target location apparatus of claim 1, wherein the target is a geographic feature.

10. The target location apparatus of claim 1, wherein the database includes at least one of a digital elevation model, a digital point precision database, digital terrain elevation data and at least one pre-stored topographic map.

11. The target location apparatus of claim 1, wherein the target is a man-made object.

12. The target location apparatus of claim 1, further comprising a display for displaying an image of the target area.

13. The target location apparatus of claim 12, wherein the target is selected by an operator.

14. The target location apparatus of claim 1, wherein the visual effects include at least one of squint effects, shadow effects, layover effects, reflectivity effects, environmental effects and texture effects.

15. The target location apparatus of claim 1, wherein the coordinate system of the projection image and the coordinate system of the image of the target area are substantially the same coordinate systems.

16. The target location apparatus of claim 1, wherein the location of the target is calculated in real-time.

17. The target location apparatus of claim 1, wherein said processor outputs geo-registration parameters for correlating a pre-stored image of the target with the current image of the target.

18. The target location apparatus of claim 16, further comprising a closed feedback loop, the closed feedback loop being configured to provide the output geo-registration parameters from a previous processing iteration to the effects processor for iterative processing of geo-registration parameters for the current image.

19. The target location apparatus of claim 1, wherein the effects processor is a PMC graphics processor, a DSP processor or an FPGA processor.

20. The target location apparatus of claim 1, wherein the visual processor is a PMC graphics processor, a DSP processor or an FPGA processor.

21. The target location apparatus of claim 1, wherein the location of the target is output as a three-dimensional location.

22. A method of processing sensor data, the method comprising the steps of:
receiving real-time image data of a target area from a sensor;
converting the real-time image data of the target area into an image of the target area;
receiving a pre-stored image of the target area in a database coordinate system;
transforming the pre-stored image of the target area into an image of the target area in a warped coordinate system;
transforming the image of the target area in a warped coordinate system to create a projection image of the target area;
comparing the projection image to the image of the target area; and
determining the location of a target in the target area based on the comparison of the projection image and the image of the target area.

23. The method of claim 22, wherein the step of transforming the image of the target area in a warped coordinate system further comprises adding effects to the image of the target in a warped coordinate system.

24. The method of claim 23, wherein the effects include at least one of squint effects, shadow effects, layover effects, reflectivity effects, environmental effects and texture effects.

25. The method of claim 22, wherein the step of receiving real-time image data of a target area from a sensor is performed by a radar sensor.

26. The method of claim 22, wherein the step of receiving real-time image data of a target area from a sensor is performed by an electro-optical sensor.

27. The method of claim 22, wherein the pre-stored image of the target area is stored in a database containing at least one of a digital elevation model, a digital point precision database, digital terrain elevation data and at least one pre-stored topographic map.

28. The method of claim 22, wherein the pre-stored image of the target area is an image based on real-time image data previously received from the sensor.

29. The method of claim 22, wherein the location of the target is calculated in real-time.

30. The method of claim 22, wherein the projection image and the image of the target area are compared in identical coordinate systems.

31. The method of claim 22, further comprising the step of determining geo-registration parameters for correlating a pre-stored image of the target area with the image of the target area.

32. The method of claim 31, further comprising the step of combining the image of the target area with a second image of the target area using the geo-registration parameters.

33. The method of claim 22, wherein the step of transforming the pre-stored image of the target area into an image of the target area in a warped coordinate system is performed by a PMC graphics processor, a DSP processor or an FPGA processor.

34. The method of claim 22, wherein the step of transforming the image of the target area in a warped coordinate system to create a projection image is performed by a PMC graphics processor, a DSP processor or an FPGA processor.
